(19) United States
(12) Patent Application Publication
(10) Pub. No.: US 2006/0080075 A1
(43) Pub. Date: Apr. 13, 2006

(54) Programmable logic controller simulator interface card

(76) Inventor: Timothy H. Young, Oceano, CA (US)

Correspondence Address: SINSHEIMER, SCHIEBELHUT, BAGGETT, 1010 PEACH STREET, SAN LUIS OBISPO, CA, 93401, US

(21) Appl. No.: 10/961,503

(22) Filed: Oct. 8, 2004

(51) Int. Cl. G06F 17/50

(52) U.S. Cl. 703/14

(57) ABSTRACT

One embodiment is a method comprising coupling a simulator card to a first adapter module; coupling the first adapter module to a first programmable logic controller card; and outputting signals from the simulator card to the first programmable logic controller through the first adapter module. Another embodiment is an apparatus for testing a programmable logic controller card comprising a simulator card for generating output signals; a first connector coupled to the simulator card; and a adapter module including a second connector and pin outs; wherein the first connector is detachably coupled to the second connector.

### BACKGROUND OF THE INVENTION

1. Field of the Invention

The present invention relates to programmable logic controller simulators. More specifically, the present invention relates to a modular interface card for programmable logic controller simulators.

2. Discussion of the Related Art

During the process of developing a machine or device that uses a programmable logic controller (PLC) it is often necessary to generate analog and/or digital signals to test the PLC after it has been programmed. In order to ensure the PLC is properly programmed analog and/or digital signals are input into the PLC to simulate conditions like pressure, temperature and switch contacts on real machines that the PLC will be used with. The testing is done for debugging the programmed PLC, controlling the process, or verifying machine response during alarm conditions.

Currently many programmers of PLCs build simulators in large enclosures with wires going to the PLC in order to generate the analog or digital input signals. This is a bulky solution that is not easily transferred between different PLCs. Furthermore, the enclosures can be very time consuming to build and the wiring within the enclosure can easily become crossed leading to hours of debugging.

### SUMMARY OF THE INVENTION

The different embodiments described herein address the above-mentioned needs as well as other needs by providing a simulator card including and adapter module.

One embodiment can be characterized as a method comprising coupling a simulator card to a first adapter module; coupling the first adapter module to a first programmable logic controller card; and outputting signals from the simulator card to the first programmable logic controller through the first adapter module.

Another embodiment can be characterized as an apparatus for testing a programmable logic controller card comprising a simulator card for generating output signals; a first connector coupled to the simulator card; and a adapter module including a second connector and pin outs; wherein the first connector is detachably coupled to the second connector.

Yet another embodiment can be characterized as a system comprising a simulator card for generating input signals, the simulator card including a first connector; a first adapter module including a second connector and a first set of pin outs, the first adapter module adapted to be detachably coupled to the simulator card; and a second adapter module including a third connector and a second set of pin out, the second adapter module adapted to be detachably coupled to the simulator card; wherein the first adapter module is designed for being coupled to a first programmable logic controller card; wherein the second adapter module is designed for being coupled to a second programmable logic controller card.

### BRIEF DESCRIPTION OF THE DRAWINGS

The above and other aspects, features and advantages of the present invention will be more apparent from the following more particular description thereof, presented in conjunction with the following drawings, wherein:

FIG. 1 is a block diagram illustrating a simulator card coupled to an adapter module in accordance with one embodiment;

FIG. 2 is a diagram illustrating a simulator card coupled to an adapter module in accordance with another embodiment;

FIG. 3 is a diagram illustrating side cross sectional view of the simulator card and the adapter module shown in FIG. 2 in accordance with one embodiment;

FIG. 4 is a diagram illustrating a programmable logic controller (PLC) card in accordance with one embodiment; and

FIG. 5 is a flow diagram illustrating a method connecting a simulator card to a PLC card in accordance with one embodiment.

Corresponding reference characters indicate corresponding components throughout the several views of the drawings. Skilled artisans will appreciate that elements in the figures are illustrated for simplicity and clarity and have not necessarily been drawn to scale. For example, the dimensions, sizing, and/or relative placement of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. It will also be understood that the terms and expressions used herein have the ordinary meaning as is usually accorded to such terms and expressions by those skilled in the corresponding respective areas of inquiry and study except where other specific meanings have otherwise been set forth herein.

### DETAILED DESCRIPTION

The following description is not to be taken in the limiting sense, but is made merely for the purpose of describing the general principles of the invention. The scope of the invention should be determined with reference to the claims.

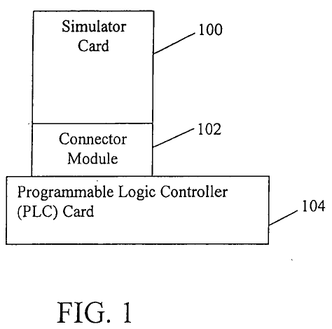

Referring to FIG. 1 a block diagram is shown illustrating a simulator card coupled to an adapter module in accordance with one embodiment. Shown is a simulator card 100, an adapter module 102, and a programmable logic controller (PLC) card 104. The simulator card is electrically coupled to the adapter module 102. The adapter module 102 is electrically coupled to the PLC card 104.

The simulator card 100 in one embodiment is a printed circuit (PC) board that generates inputs for testing the PLC card 104. The simulator card 100 generates digital and/or analog inputs. The simulator card 100 optionally includes a power supply, however, an external power source is used in some embodiments. The simulator card 100 also includes a connector for mating with the adapter module 102.

The adapter module 102 is a PC board that includes a connector portion and a pin out portion in accordance with one embodiment. The connector portion mates with the connector of the simulator card 100. The pin out portion connects with the PLC card 104. In order to support the transferability of the simulator card 100 between many different PLC cards that have different pin out or input connections, the adapter module 102 can be easily removed and replaced. Each PLC card has a different pin out configuration, thus, instead of having a simulator card 100 for every PLC card 104 on the market, the simulator card 100 is electrically coupled to the adapter module. In one embodiment, each PLC card 104 has a different adapter module 102 with pin outs that correspond to the specific PLC card. Advantageously, this provides for a very inexpensive solution for interchanging a simulator card 100 between different PLC cards.

The PLC card 104 is any type of programmable controller. Optionally, an adapter module 102 is developed for each PLC card that is available. However, for example, when two different PLC cards have the same pin out configuration, one adapter module 102 can optionally be used for the two different PLC cards.

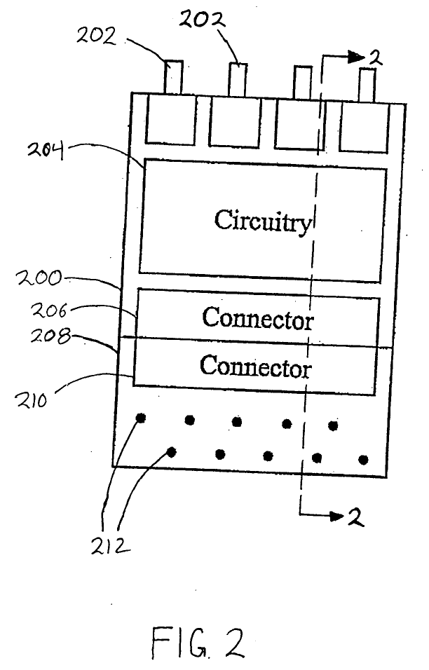

Referring next to FIG. 2 a diagram is shown illustrating a simulator card coupled to an adapter module in accordance with another embodiment. Shown is a simulator card 200, a plurality of controls 202, circuitry 204, a first connector 206, an adapter module 208, a second connector 210, and pin outs 212.

The simulator card 200 includes the plurality of controls 202, the circuitry 204, and the first connector 206. The adapter module 208 includes the second connector 210, and the pin outs 212. As is shown, the first connector 206 of the simulator card 200 connects with the second connector 210 of the adapter module 208. In one embodiment, the simulator card 200 and the adapter module 208 are PC boards.

The plurality of controls 202 are, for example, knobs or switches. To simulate digital signals toggle switches are used in one embodiment to turn the outputs of the simulator card on or off corresponding to a high or low digital signal, respectively. In one embodiment, manual switches are used, however, other types of switches such as are known in the art can be used. To simulate analog signals knobs are used to control variable resistances. The variable resistances create different current outputs. For example, knobs are used to vary the resistance of potentiometers. The variable resistance along with the circuitry then generates outputs, for example, between 4 milliamps and 20 milliamps.

In one embodiment, the circuitry comprises simple circuitry for generating the digital or analog outputs that are controlled by the plurality of controls 202. To generate digital outputs, transistors connected to the controls (for example, switches) are used to generate high or low outputs at the first connector 206 of the simulator card 200. To generate analog outputs, operational amplifiers connected to the controls 202 (for example, potentiometers) generate variable current outputs at the first connector 206 of the simulator card 200.

The second connector 210 of the adapter module 208 is electrically coupled to the first connector 206 of the simulator card 200. In one embodiment, the first connector 206 and the second connector 210 are a male and female type connector such that wiring mistakes between the simulator card 200 and the adapter module 208 are prevented. Other types of connectors, such as are known in the art are used in different embodiments. The pin outs 212 are electrically coupled to the outputs of the simulator card 200 through the second connector 210. The second connector 210 is electrically coupled to metal traces on a PC board. The metal traces then connect to the pin outs 212. Optionally, the adapter module 208 includes resistances or other electrical components that can alter the input to a PLC card.

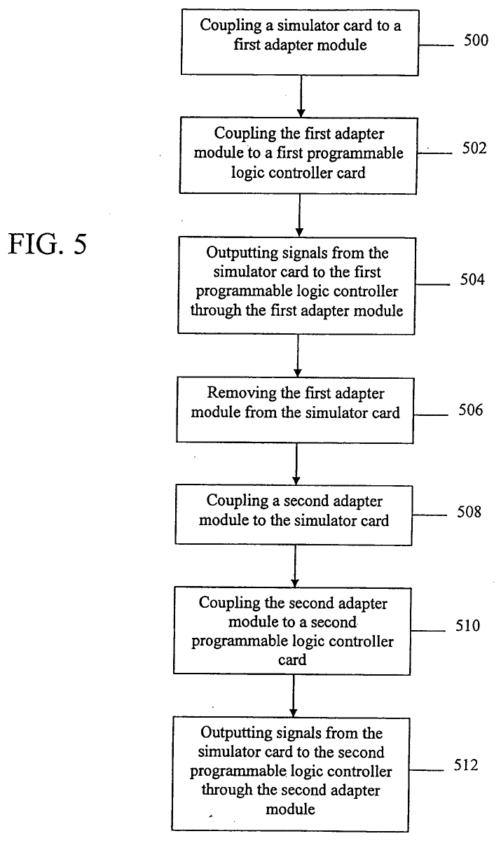

Advantageously, the adapter module 208 is designed such that the pin outs 212 match with pin outs of a PLC card (shown in FIG. 5). This allows the same simulator card to be used with many different PLC cards by switching to the adapter module 208 designed for the specific input connections of the PLC card. The adapter module 208 is relatively simple in design and inexpensive as compared to the simulator card 200, thus replacing the adapter module 208 is much more efficient than having a simulator module 200 built for each different PLC card.

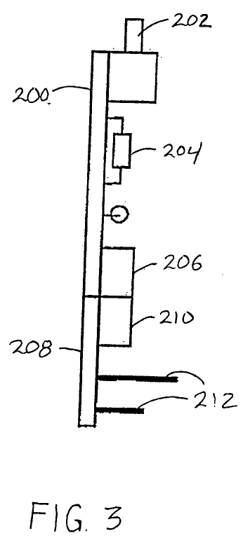

Referring to FIG. 3 a diagram is shown illustrating side cross sectional view of the simulator card 200 and the adapter module 208 shown in FIG. 2 in accordance with one embodiment. Shown is the simulator card 200, the control 202, the circuitry 204, the first connector 206, the adapter module 208, the second connector 210, and the pin out 212.

In one embodiment the simulator card 200 and the adapter module 208 are implemented on a printed circuit board. This provides for a compact and reliable testing device that can be interchangeably used with a plurality of PLC cards by removing and replacing the adapter module 208.

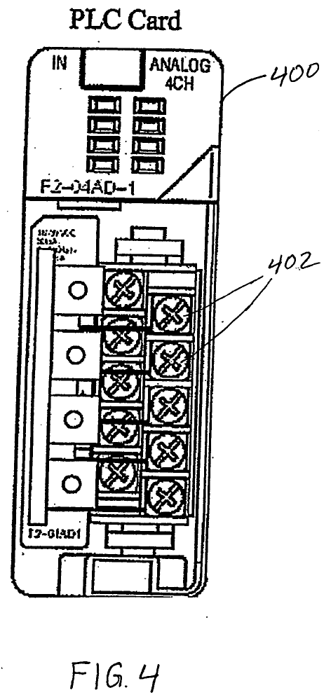

Referring now to FIG. 4 a diagram is shown illustrating a programmable logic controller (PLC) card in accordance with one embodiment. Shown is a PLC card 400 and a plurality of input connections 402.

The pin outs 212 of the adapter module 208 (shown in FIGS. 2 and 3) connect with the input connections 402. Screws are then tightened down to hold the adapter module 208 in place. This provides an electrical connection between the simulator module 200 and the PLC card 400. Additionally, the output from the simulator card 200 connects to the proper input in the PLC card 400 as the adapter module 208 is designed to match the input connections 402 specific to the PLC card 400.

Once the simulator card 200 is electrically coupled to the PLC card 400 through the adapter module 208 the PLC card 400 can be tested.

Referring to FIG. 5 a flow diagram is shown illustrating a method connecting a simulator card to a PLC card in accordance with one embodiment.

In step 500, a simulator card is coupled to a first adapter module. The adapter module includes, in one embodiment, a pin out that is designed for a PLC card. In step 502, the first adapter module is coupled to a first programmable logic controller card. Next, in step 504, signals are output from the simulator card to the first programmable logic controller through the first adapter module. The signals can be either digital or analog type input signals.

In another embodiment, the first adapter module is then removed from the simulator card in step 506. Next, in step 508 a second adapter module is coupled to the simulator card. In step 510, the second adapter module is coupled to a second programmable logic controller card and in step 512 signals are output from the simulator card to the second programmable logic controller through the second adapter module.

While the invention herein disclosed has been described by means of specific embodiments and applications thereof, other modifications, variations, and arrangements of the present invention may be made in accordance with the above teachings other than as specifically described to practice the invention within the spirit and scope defined by the following claims.

I claim:

1. A method comprising:
coupling a simulator card to a first adapter module;
coupling the first adapter module to a first programmable logic controller card; and
outputting signals from the simulator card to the first programmable logic controller through the first adapter module.

2. A method of claim 1 further comprising:
removing the first adapter module from the simulator card;
coupling a second adapter module to the simulator card;
coupling the second adapter module to a second programmable logic controller card; and
outputting signals from the simulator card to the second programmable logic controller through the second adapter module.

3. The apparatus of claim 2 wherein the simulator card comprises a first printed circuit board.

4. The apparatus of claim 2 wherein the adapter module comprises a second printed circuit board.

5. The apparatus of claim 2 wherein the second adapter module is designed for the second programmable logic controller card.

6. The apparatus of claim 1 wherein the first adapter module is designed for the first programmable logic controller card.

7. The system of claim 1 further comprising adjusting at least one of a plurality of controls to change the output signals of the simulator card.

8. An apparatus for testing a programmable logic controller card comprising:
a simulator card for generating output signals;
a first connector coupled to the simulator card; and
a adapter module including a second connector and pin outs;
wherein the first connector is detachably coupled to the second connector.

9. The apparatus of claim 8 wherein the simulator card comprises a first printed circuit board.

10. The apparatus of claim 9 wherein the adapter module comprises a second printed circuit board.

11. The apparatus of claim 8 wherein the adapter module is detachably coupled to the simulator card such that a second adapter module can be coupled to the simulator card.

12. The apparatus of claim 11 wherein the second adapter module is designed for a second programmable logic controller card.

13. The system of claim 8 further comprising a control for controlling the output signal of the simulator card.

14. The system of claim 13 wherein the plurality of controls comprise a plurality of switches.

15. The system of claim 13 wherein the plurality of controls comprise a plurality of knobs.

16. A system comprising:
a simulator card for generating input signals, the simulator card including a first connector;
a first adapter module including a second connector and a first set of pin outs, the first adapter module adapted to be detachably coupled to the simulator card; and
a second adapter module including a third connector and a second set of pin out, the second adapter module adapted to be detachably coupled to the simulator card;
wherein the first adapter module is designed for being coupled to a first programmable logic controller card;
wherein the second adapter module is designed for being coupled to a second programmable logic controller card.

17. The system of claim 16 further comprising a plurality of controls for controlling output signals of the simulator card.

18. The system of claim 17 wherein the plurality of controls comprise a plurality of switches.

19. The system of claim 17 wherein the plurality of controls comprise a plurality of knobs.

20. The system of claim 16 further comprising circuitry for controlling the output signal from the simulator card.
